(19) United States
(12) Patent Application Publication
(10) Pub. No.: US 2016/0088831 A1
(43) Pub. Date: Mar. 31, 2016

(54) DECOY SYSTEM OR OTHER REPRESENTATION OF AN ANIMAL

(71) Applicant: Digital Impact LLC, Lansdowne, PA (US)

(72) Inventor: Michael Mormile, Wallingford, PA (US)

(21) Appl. No.: 14/865,492

(22) Filed: Sep. 25, 2015

Related U.S. Application Data
(60) Provisional application No. 62/055,997, filed on Sep. 26, 2014.
(60) Provisional application No. 62/062,416, filed on Oct. 10, 2014.

(51) Int. Cl. A01M 31/06

(52) U.S. Cl. CPC A01M 31/06

(57) ABSTRACT

A decoy or other representation of an animal comprising a substantially planar body cut from a sheet of weatherproof or weather resistant material, the body having a periphery corresponding to the animal, the body having at least a first side having a first printed graphic comprising a photo-realistic image corresponding to one side of the animal, typically also a second side having a second graphic comprising to a photo-realistic image corresponding to an opposite side of the animal. A stake having a first end configured to be removably secured to the body and a second end configured to be secured into the earth may be provided. The body preferably has a relatively low-glare, matte finish coating over the first and second graphics.

### CROSS REFERENCE TO RELATED APPLICATIONS

This application claims priority to U.S. Provisional Application Ser. No. 62/062,416, filed Oct. 10, 2014, and U.S. Provisional Application Ser. No. 62/055,997, filed Sep. 26, 2014, both titled 2-D HUNTING DECOYS WITH PROTECTIVE ANTI-GLARE COATING, METAL STAKE, AND SYSTEM FOR REMOVABLE ATTACHMENT THERETO, the contents of which are hereby incorporated by reference.

### BACKGROUND OF THE INVENTION

Various types of hunting decoys are known in the art. 3-dimensional decoys are typically fashioned of wood, plastic, or the like, and are generally costly to produce. A need for producing less-expensive, but still sufficiently realistic decoys or other representations of animals remains.

### SUMMARY OF THE INVENTION

One aspect of the invention is a system for providing a representation of an animal. The system comprises a substantially planar body cut from a sheet of material, the body having a periphery corresponding to the animal and a first side having a first printed graphic comprising a photo-realistic side view image corresponding to one side of the animal and a second side having a second graphic comprising to a photo-realistic side view image corresponding to an opposite side of the animal. The body has one or more interfaces for securing the body to an object. The system further comprising a stake having a first end configured to be removably secured to the body at the interfaces and a second end configured to be secured into the ground. Preferred embodiments comprise a matte finish coating over each respective image on the body, more preferably a matte finish coating having a gloss reading using a ASTM D523 test of less than 15, more preferably less than 12, and most preferably less than 10 Gloss Units on a scale of 100. The stake may be cut from a substantially planar sheet of metal, and the one or more body interfaces comprise a bottom slot for receiving the stake, a top slot for receiving the stake, and one or more holes configured to align with one or more holes in the stake adjacent the first end when the stake is received within the top slot and bottom slot, the system further comprising one or more fasteners sized to secure the body to the stake through the one or more holes.

Another aspect of the invention comprises a plurality of hunting decoys, each decoy comprising one body and one stake as described above. In one embodiment, the plurality of bodies comprises at least a first body and a second body, wherein the first body differs from the second body with respect to a characteristic selected from the group consisting of: pose, gender, coloration, viewing angle, or a combination thereof.

Yet another aspect of the invention comprises a representation of an animal configured to be fixed to any object, not limited to a stake, the representation comprising a substantially planar body cut from a sheet of weatherproof or weather resistant material, such as HDPE, the body having a periphery corresponding to the animal, the body having at least a first side having a first printed graphic comprising a photo-realistic side view image corresponding to one side of the animal, a matte finish coating over the printed graphic, the matte finish coating having a gloss reading using a ASTM D523 test in the range of less than 15, more preferably less than 12, and most preferably less than 10 Gloss Units on a scale of 100, and the body having one or more interfaces for securing the body to the object.

### BRIEF DESCRIPTION OF THE DRAWINGS

FIG. 1A is a reduced-size depiction of a left-facing side of an exemplary duck body showing slots and holes for affixing to the stake.

FIG. 1B is a reduced-size depiction of a right-facing side of the exemplary duck body of FIG. 1A.

FIG. 2A is a schematic drawing of a first exemplary stake.

FIG. 2B is a schematic drawing of a second exemplary stake.

FIG. 3A depicts a plan view of a portion of one side of an exemplary body, showing an exemplary stake threaded through the slots with the holes in the stake aligned with the holes in the body.

FIG. 3B depicts a plan view of a portion of the opposite side of the body and stake of FIG. 3A.

FIG. 3C depicts a cross-sectional view of the body and the stake of FIG. 3A taken across the plane 3C, further showing exemplary fasteners.

FIG. 4 depicts exemplary images corresponding to a set of decoys comprising a plurality of different bodies each having a different characteristic from other bodies in the set.

### DETAILED DESCRIPTION OF THE INVENTION

The invention relates to representations of an animal for affixing to an object, such as but not limited to systems for staking representations of the animal into the ground, such as but not limited for use as hunting decoys. The representation of the animal is not limited for any particular purpose, however. So, for example, the representation may be of a type of animal that is typically hunted, such as the exemplary fowl discussed herein later, in which the representations are useful for attracting the animals, or the representation may be of a type of animal not for attracting animals, but for repelling them, such as predator animals (e.g. wolfs or dogs, such as for repelling geese, etc.). Additionally, a user may wish to have a realistic representation of an animal that has no purpose with respect to attracting or deterring other animals. Although discussed primarily herein with respect to two-sided representations of an animal for staking into the ground, the representations may have lifelike or photo-realistic graphics printed on only one side. Likewise, the representations may be configured to be affixed to any object, not limited to the ground. For example, a representation of an owl may be configured to be affixed with an unprinted side against a wall, or a 2-sided representation of a predator bird, such as a hawk, owl, eagle, falcon, etc., may be configured to be affixed to a member secured to a roof, such as to a weathervane or antenna. A member configured to be secured to a float, for example, may be useful so that waterfowl hunting decoys of the same body type described herein can be placed in water rather than on land.

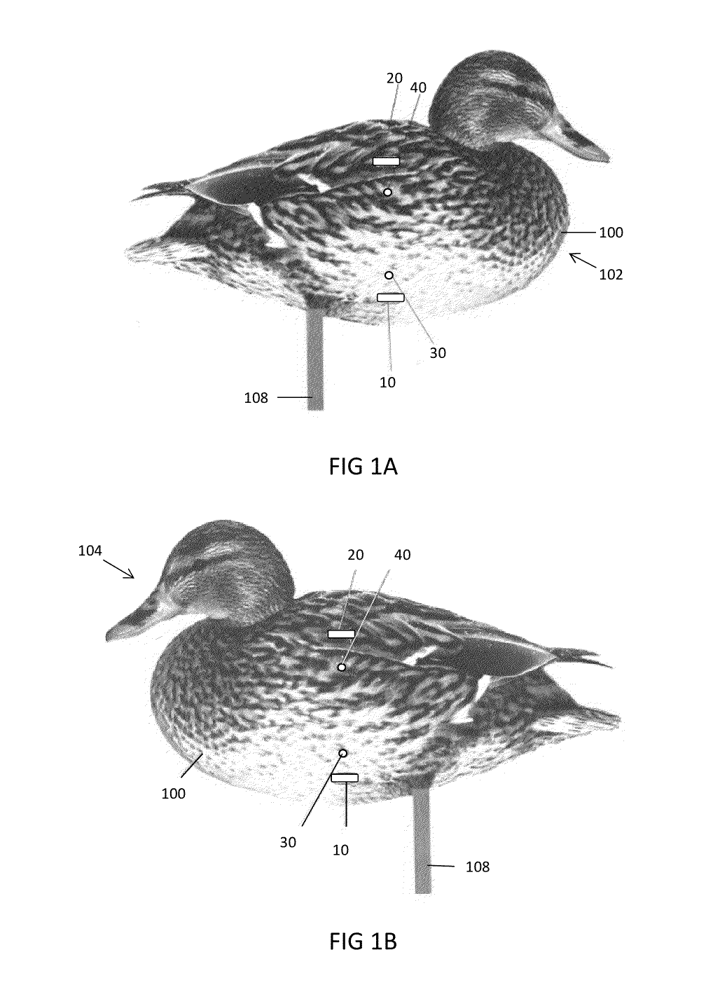

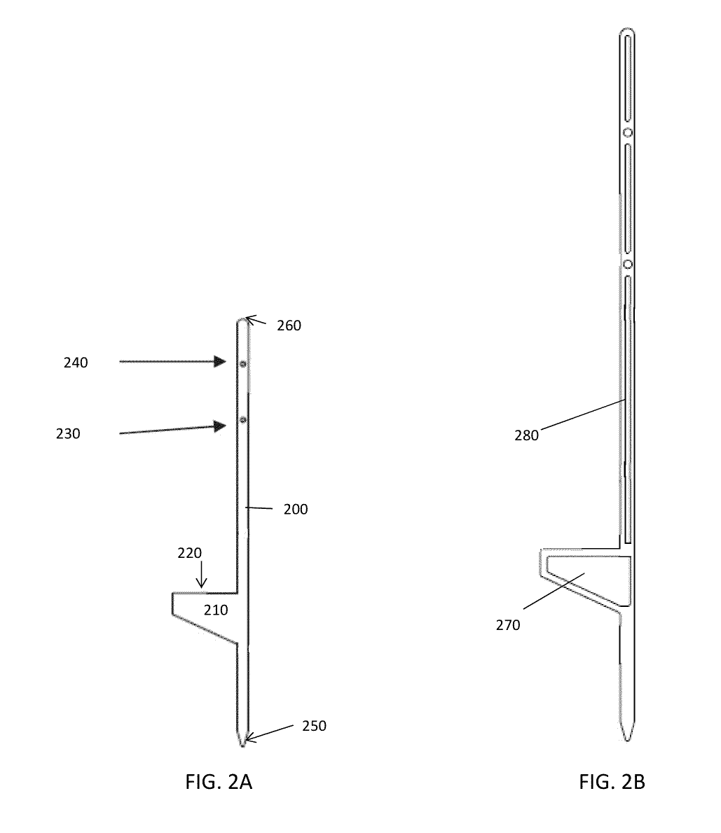

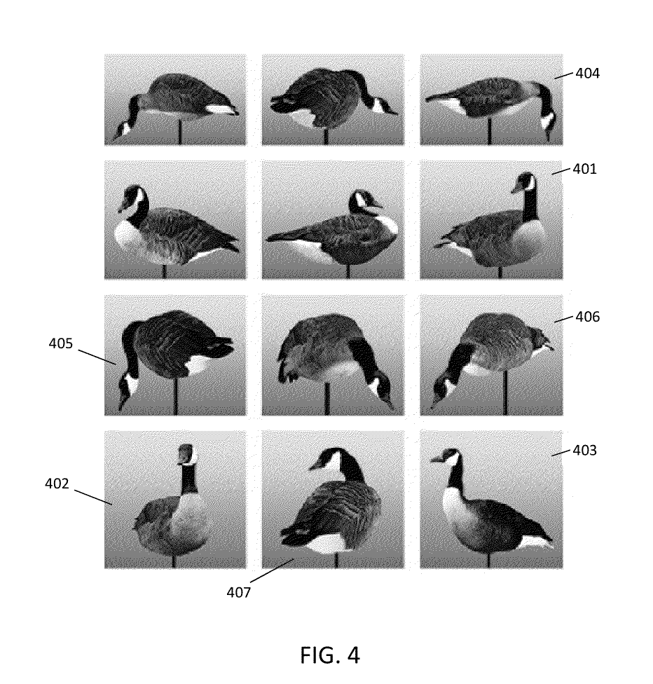

Referring now to the figures, each representation of the animal comprises at least a body, such as is depicted in FIGS. 1A and 1B, and in most embodiments, a member configured to affix the body to an object, such as a stake, like those depicted in FIGS. 2A and 2B, for staking the animal representation into the ground. In a two-sided embodiment, a first side of the body has a first printed graphic comprising a photo-realistic side view image corresponding to one side of the animal, and the second side has a second graphic comprising to a photo-realistic side view image corresponding to an opposite side of the animal. So, for example, if the first side is an image of a right-facing view of the animal, the second side is an image of a left-facing view of the animal. The first and second side graphics may comprise, for example, photographs of the same animal taken from each of the respective sides, or the graphic for the first side may be the exact same graphic as for the second side, with the first and second side being mirror images of one another. The first and second side may also be substantially mirror images of one another in that the images are essentially identical, but one side may have immaterial variations relative to the other. The term “side” as used herein does not imply any particular viewing angle of the animal relative to its head and tail—thus if the first side is a front side view of the animal, the second or opposite side view would be a rear side view of the animal, and the viewing angles may be anywhere in between, as depicted with respect to FIG. 4.

The body may comprise, for example, a weatherproof or weather resistant sheet of material suitable for outside use, such as but not limited PVC or HDPE, such as a ⅛″ PVC or 0.055″ HDPE sheet cut into the shape of the animal. The body is referred to herein as “substantially planar” meaning that it comprises two planar surfaces spaced apart from one another by the thickness of the sheet stock from which the body has been formed, with the thickness of the sheet stock being substantially smaller than the overall width of the sheet. Decoys having such a body may be referred to as a 2-dimensional or 2-D decoy, because the overall shape of the animal is a dimensionally accurate representation of the length and height of a representative animal, but the thickness of the sheet stock from which the decoy is made is not intended to be a dimensionally accurate representation of the width of the animal. By contrast, decoys referred to as 3-dimensional or 3-D decoys have an overall shape that is substantially dimensionally accurate relative to a representation of the animal in all 3 dimensions of the animal: length, width, and height.

Although the most efficient method for making the 2-D decoys described herein is by printing the graphics on a 2-D sheet stock and cutting the bodies from that stock, the invention is not limited to any particular method of manufacture or construction of the substantially planar body. The term “substantially planar” as used herein contemplates that the surface of the sheet stock may vary over the course of each of the front and back surfaces, and may even be intentionally textured to have some variations in topography on the surface. Deviations from the average thickness of the body, however, are generally less than 50% of the average thickness of the body and therefore do not produce a body that approaches dimensional accuracy with respect to the width of the genuine animal represented.

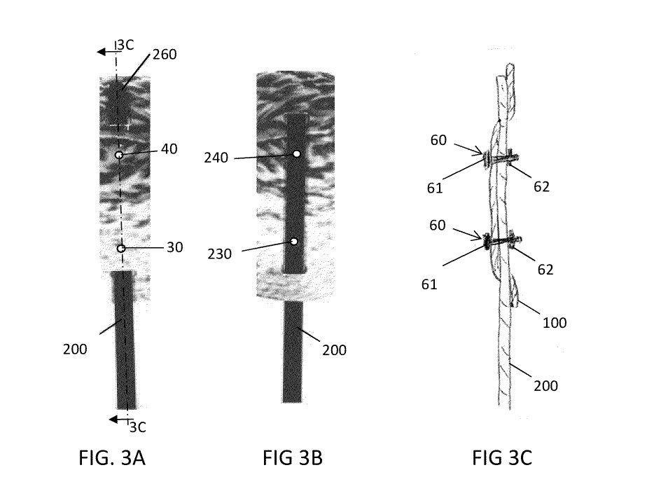

In the exemplary embodiment shown in FIGS. 1A and 1B, body 100 comprises a representation of a duck. Body 100 has a periphery corresponding to the duck, with realistic printing of features of the duck on both sides of the body coextensive with the cut shape. FIG. 1A shows a first side 102 of body 100 comprising an image printed thereon corresponding to a right-facing side of the duck, and FIG. 1B shows a second side 104 of body 100 comprising an image printed thereon corresponding to a left-facing side of the duck. Slots 10 and 20 spaced apart from one another, and holes 30, 40 spaced apart from one another between the slots, comprise interfaces for affixing the body to the stake. As depicted in FIGS. 1A and 1B, the slots are located such that when the stake is threaded through them (as depicted in FIGS. 3A-3C), the stake is positioned approximately parallel to and spaced apart from the downward protruding leg portion 108 of the body, such that the downward protruding portion and the stake together represent the two legs of the duck. Bodies, particularly of birds, may also be provided without downward protruding leg portions, such that the stake alone is the only representation of a leg of the animal.

Decoys may be sold as part of a set of decoys comprising multiple poses of the same type of animal, such as but not limited to ducks, geese, or turkeys, preferably representing one or more genders, colorations, poses and/or viewing angles of the type of animal. FIG. 4 depicts exemplary images corresponding to a set of decoys comprising a plurality of different geese with each goose body having a different characteristic from other bodies in the set, including one or more alert poses (e.g. 401, 402, and 403), one or more feeding poses (e.g. 404, 405, 406) and at least one resting pose 407, as well as from different views, including from a substantially side view (e.g. 403, 404), a substantially front view (e.g. 402), a substantially back view (e.g. 407), and various views from other angles.

The body is preferably coated with a flat matte protective coating that has one or more of the following attributes: UV-protection, metal/lead free, scuff and/or scratch resistant, chemical resistant, and glare-reducing. In one preferred embodiment, the protective coating is a proprietary “Flat Matte” blend sourced from Brilliant Coating Solutions of Columbia, Md., product ID 1114, manufactured especially for Digital Impact LLC of Yeadon, Pa. The protective coating may also be known by the name Flat Matte Flex-Coat 200FM128, supplied by Prime Coatings of Pewaukee, Wis.

A first exemplary stake 200 is depicted in FIG. 2A, such as for staking the body into the ground. The stake preferably comprises a weather resistant metal. The exemplary stake has a pointed distal end 250 and a rounded proximal end 260, and has a protrusion 210 located between the distal end and the proximal end. Although preferably closer to the distal end 250 than the proximal end 260, the location of the protrusion 210 is not critical. The protrusion is configured to permit a user to apply a downward force on the proximal side 220 of the protrusion to help push the stake into the ground. The protrusion is generally positioned so that after the user has applied the force to the protrusion sufficient to drive the stake into the ground for enough that the proximal side 200 of the protrusion 210 is approximately level with the ground, the amount of stake buried in the ground is sufficient to hold the body in place, assuming routine wind and routine soil characteristics to provide an expected amount of resistance to movement of the stake.

Stake 200 shown in FIG. 2A depicts a solid construction stake in a relatively smaller size, such as for an exemplary duck decoy. Stake 202 shown in FIG. 2B depicts a lighter-weight construction stake in a relatively larger size, such as for an exemplary goose/turkey hen decoy. In the lighter weight construction, portions of the metal have been cut away to reduce weight, including a cutout 270 centered in the protrusion and one or more longitudinal cutouts 280 from the center of the upper portion of the stake proximal of the protrusion. In the embodiment depicted, no cutouts are located distal of the protrusion. Although the relatively smaller size is depicted with solid construction and the relatively larger size is depicted with lightweight construction, either construction may be used with any size stake.

The stake preferably has one or more holes 230 and 240 as shown in FIG. 2A, spaced apart from one another, configured to align with matching holes 30 and 40 in the body, as shown in FIGS. 1A and 1B. FIGS. 3A and 3B depict a portion of body 100 from opposite sides, and FIG. 3C depicts a cross section of the stake of FIG. 3C, showing stake 200 threaded through slot 10 and 20 for receiving stake 300. One or more fasteners 60 of sufficient length may be used to removably pin the body to the stake through the mating holes, such that as depicted in the example shown in FIG. 3C, one fastener 60 is placed through holes 30 and 230 and the other is placed through holes 40 and 240. Suitable fasteners may comprise a rivet, a nut 62 and bolt 61 as depicted in FIG. 3C, a cotter pin, or any other fastener as is known in the art and suitable for securing the body, either removably or non-removably, to the stake. Lightweight, weather-resistant fasteners, such as fasteners made of plastic are ideal.

The invention is not limited to the number and position of holes in the stake and the body. Variations may be provided with respect to the number of holes in the stake and the body, including embodiments with a single hole and/or a looser fit in the slots to permit some wiggle or movement of the decoys, if desired. Thus, although depicted with 2 mating holes for affixing the body to the stake in FIGS. 1A and 1B, it should be understood that more or less than 2 holes may be desired, based on the size of body to be supported. For example, a relatively large body and stake combination, such as for a turkey male, may have 3 holes. Also, although depicted with holes 30, 40 positioned between slots 10, 20, location of the hole or holes relative to the slots of may be above, below, in between the slots, or a combination thereof.

The invention is not limited to any particular materials of construction, configurations, or sizes. In general, however, the body has a lifelike size for the animal represented, and the stake is sized to provide sufficient support for the representation, meaning that larger stakes may be needed for larger animals. For example, and without limitation, exemplary stakes may have a height between the distal and proximal ends of approximately 18-20 inches for a duck decoy, 24-26 inches for a goose or female turkey decoy, and 34-37 inches for a male turkey decoy. The protrusions may protrude outward from the edge of the stake between 2.5 to 3 inches and may have a height of approximately 2 to 2.5 inches. A preferable stake width is approximately a half an inch. The holes in the stake may be sized to accommodate quarter-inch diameter fasteners, such as for example, holes of 0.29 inches in diameter. For the lightweight construction depicted in FIG. 2B, the longitudinal cutout 280 may have a width of, for example, 0.167 inches centered within the 0.5 width of the stake. The stake may be cut from a sheet of metal, such as for example 0.156″ thick, 1050 Annealed spring steel. Weatherproofing or weather resistance may be provided, such as for example, by coating the stake with a powder coating, such as but not limited to a powder coating rated to provide at least 5-Year durability. The stake configuration is not limited to any particular type of weather-resistant coating, however.

Exemplary Process for Creating the Matte Finish

The bodies describe herein may be fabricated by the following exemplary process:

1) The images corresponding to the animal are digitally printed directly on a substrate, such as 0.055 HDPE, using, for example, a Durst UV printer with UV printing inks. For 2-sided embodiments, the images are aligned so that a first side is printed on one side of the substrate, and a second side, such as a substantial mirror image of the first side, is printed on the opposite side of the substrate in substantial alignment with the image on the first side. Multiple images may be printed on a single large substrate, and later cut to form multiple bodies from the single sheet.

2) A laminate is applied over the images to reduce glare. An exemplary process comprises application of the laminate using an ATC UV 80″ wide liquid coater, in which the liquid coating is poured on a spinning rubber anilox roll, which transfers the liquid onto the sheet, leaving about 0.5 mil of coating.

3) The sheet is transferred through a UV light oven, which cures the laminate layer as the light contacts the applied laminate liquid. In an exemplary process, the sheet is fed through the oven at about 20 feet per minute.

4) The sheet is cut along the peripheries of the body or bodies printed thereon. The cutting step may also comprise cutting the interfaces for the member, if any, to be attached to the body, such as the slots or holes described herein for receiving and affixing the body to the stake. The cuts may be performed such that the slots and holes are fully formed, or the cuts may be only partially completed to form outlines of the slots and holes so that a user can readily punch out the cutaway portions, such as when affixing the stake or other member to the body.

A preferred laminate comprises Flat Matte Flex-Coat 200FM128, supplied by Prime Coatings of Pewaukee, Wis., which is a UV-cured matte finish. Although not limited to any particular brand or type of coating, it is preferable that the laminate coating is capable of providing, after application and curing as described above, a gloss reading of less than 15, more preferably less than 12, and most preferably less than 10, and generally in the range of approximately 5-15, or more preferably 8-12 Gloss Units on a scale of 100 using ASTM (American Society for Testing and Materials) D523 (or, as referred to by some in the field, a “Leneta test”). In general, standard gloss tests are performed using the same type substrate to get a controlled gloss level reading number, because measured gloss for the same image and laminate may vary dependent on the substrate. Thus, performing the gloss test on an exemplary image processed according to the steps above and on the substrate prior to processing both preferably provide a less than 15, more preferably less than 12, and most preferably less than 10 GU reading using the subject test.

In one embodiment, an optional pre-coating layer of a printing pre-coat known in the art may be applied before printing to allow a better bond between the ink and the substrate. This allows the images applied to the substrate to be very durable and scuff- and scratch-resistant, which may improve longevity in use.

It should be understood that the finish is not limited to any particular brand or type of matte finish laminate coating. Any coating that provides a low gloss reading, preferably less than 10 GU, without clouding or otherwise negatively impacting the visibility of the underlying printed image is preferred.

Furthermore, it should be understood that the printing, lamination, and curing process is not limited to any particular substrate or set of machinery. The process described above, however, permits direct printing of an image on a plastic substrate, such as HDPE, in a way that provides a low gloss image, which is a more cost-effective and efficient method for delivering a low-gloss, 2D decoy than prior art methods known and used in the field. The resulting decoys are weather resistant or weather proof and exceptionally lightweight, especially when combined with the lightweight style stake, thus enabling a hunter to more easily carry the set of decoys to a location where the decoys can be spread out. In particular, the decoys may be useful to attract animals from a location from which side views of the decoys are visible.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A system for providing a decoy or other representation of an animal, the system comprising:
at least one substantially planar body cut from a sheet of weather resistant or weatherproof material, the body having a periphery corresponding to the animal and a first side having a first printed graphic comprising a photo-realistic side view image corresponding to one side of the animal and a second side having a second graphic comprising to a photo-realistic side view image corresponding to an opposite side of the animal, the body having one or more interfaces for securing the body to an object;
at least one stake having a first end configured to be removably secured to the body at the interfaces and a second end configured to be secured into earth.

2. The system of claim 1, wherein the first graphic and the second graphic consist essentially of mirror images of one another.

3. The system of claim 1, wherein the substantially planar body comprises PVC or HDPE.

4. The system of claim 1, wherein the stake comprises metal.

5. The system of claim 1, wherein each side of the body has a matte finish coating over the respective image.

6. The system of claim 5, wherein the matte finish coating has a gloss reading using a ASTM D523 test in the range of less than 15 Gloss Units on a scale of 100.

7. The system of claim 6, wherein the matte finish coating has a gloss reading of less than 12 Gloss Units on a scale of 100.

8. The system of claim 7, wherein the matte finish coating has a gloss reading of less than 10 Gloss Units on a scale of 100.

9. The system of claim 5, wherein the body comprises a product made by a process comprising the steps of:
a) printing the first graphic image on a first side of the sheet of and the second graphic image on a second side of the sheet;
b) applying the matte finish coating over the first graphic image and the second graphic image
c) curing the matte finish coating; and
d) cutting the body from the sheet.

10. The system of claim 1, wherein the stake comprises a form cut from a substantially planar sheet of metal, and the one or more body interfaces comprise a bottom slot for receiving the stake, a top slot for receiving the stake, and one or more holes configured to align with one or more holes in the stake adjacent the first end with the stake threaded through the top slot and bottom slot, the system further comprising one or more fasteners configured to secure the body to the stake through the one or more holes in the body and the stake.

11. The system of claim 1, wherein the stake comprises a protrusion proximal the second end sized to receive a distal force applied by a foot of a user.

12. The system of claim 9, wherein the stake comprises one or more cutout areas in a longitudinal portion of the stake, in the protrusion, or a combination thereof.

13. The system of claim 1, wherein the system comprises a plurality of hunting decoys, each decoy comprising one substantially planar body and one stake.

14. The system of claim 13, wherein the plurality of decoys comprises at least a first body and a second body, wherein the first body differs from the second body with respect to a characteristic selected from the group consisting of: pose, gender, coloration, viewing angle, or a combination thereof.

15. The system of claim 13, wherein the animal represented by each of the plurality of decoys is selected from the group consisting of: ducks, geese, and turkeys.

16. The system of claim 13, wherein the body of each of the plurality of decoys consists of HDPE, and each side of the body has a matte finish coating over the respective image, the matte finish coating having a gloss reading using a ASTM D523 test of less than 15 Gloss Units on a scale of 100.

17. The system of claim 13, wherein:
each body comprises a product made by a process comprising the steps of:
a) printing the first graphic image on a first side of the sheet and the second graphic image on a second side of the sheet;
b) applying the matte finish coating over the first graphic image and the second graphic image
c) curing the matte finish coating; and
d) cutting the body from the sheet;
each stake comprises a form cut from a substantially planar sheet of metal;
the one or more body interfaces comprises at least a bottom slot for receiving the stake, a top slot for receiving the stake, and one or more holes configured to align with one or more holes in the stake adjacent the first end with the stake threaded through the top slot and bottom slot; and
each decoy further comprises one or more fasteners sized to secure the body to the stake through the one or more holes in the stake and the body.

18. A representation of an animal configured to be fixed to an object, the representation comprising:
a substantially planar body cut from a sheet of weatherproof or weather resistant material, the body having a periphery corresponding to the animal, the body having at least a first side having a first printed graphic comprising a photo-realistic side view image corresponding to one side of the animal, a matte finish coating over the printed graphic, the matte finish coating having a gloss reading using a ASTM D523 test of less than 15 Gloss Units on a scale of 100, the body having one or more interfaces for securing the body to an object.

19. The representation of claim 18, further comprising a member configured to be removably secured to the body at the one or more interfaces, the member configured to secure the body to the object.

20. The representation of claim 19, wherein the object to which the representation is configured to be fixed comprises land, and the member is a stake configured to be implanted into the land.
